(19) United States
(12) Patent Application Publication
(10) Pub. No.: US 2013/0107040 A1
(43) Pub. Date: May 2, 2013

(54) SECURITY MONITORING SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/314,195

(22) Filed: Dec. 8, 2011

(30) Foreign Application Priority Data
Oct. 31, 2011 (TW) 100139612

(51) Int. Cl. H04N 7/18

(52) U.S. Cl. 348/140; 348/E07.085

(57) ABSTRACT

An exemplary security monitoring method includes first obtaining an image of a monitoring place captured by a camera, the image comprising distance information between the camera and captured objects, then extracting the distance information from the obtained image, next comparing the distance information of the obtained image with that of a pre-stored object model to determine whether the obtained image matches the pre-stored object model; and lastly determining that there is object(s) removed from or remained in the monitoring place when the obtained image does not match the pre-stored object module, and generating a prompt message to prompt user that there is object(s) removed from or remained in the monitoring place.

### BACKGROUND

1. Technical Field

The present disclosure relates to a security monitoring system and a security monitoring method, and particularly, to a security monitoring system and a method capable of monitoring object(s) removed from or remained in a place.

2. Description of Related Art

A conventional security monitoring system which captures image through a two-dimensional (2D) camera determines whether an object is lost from a place or remained in a place through at least one monitor who monitors the place all the time. However, images captured by the 2D camera do not include the distance between the 2D camera and the object in the place, if the object in the monitored place is stolen but a picture of the stolen object is placed in the same place to substitute the stolen object, the security monitoring system may not identify the object has been stolen due to the substitute. It is therefore desirable to have a new security monitoring system to resolve the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram illustrating a security monitoring device connected with a camera, in accordance with an exemplary embodiment.

FIG. 2 is a block diagram of a security monitoring system of the security monitoring device of FIG. 1.

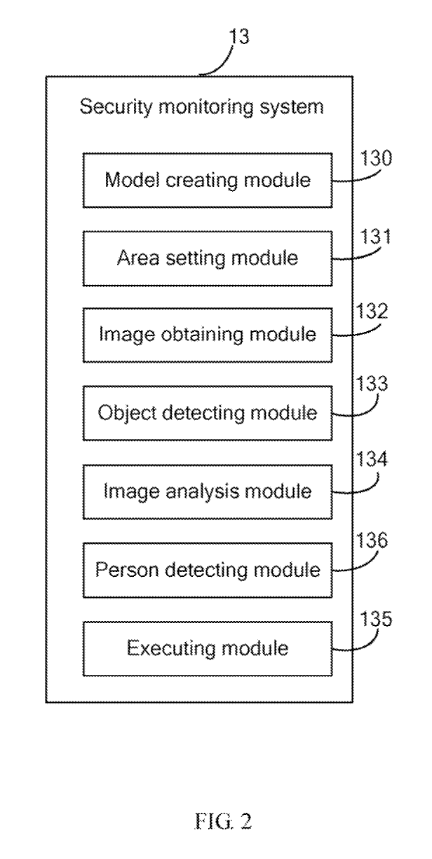

FIGS. 3A-3E are a series of schematic views showing how to determining a monitoring place.

FIG. 4 is a flowchart of a security monitoring method in accordance with an exemplary embodiment.

### DETAILED DESCRIPTION

The embodiments of the present disclosure are now described in detail, with reference to the accompanying drawings.

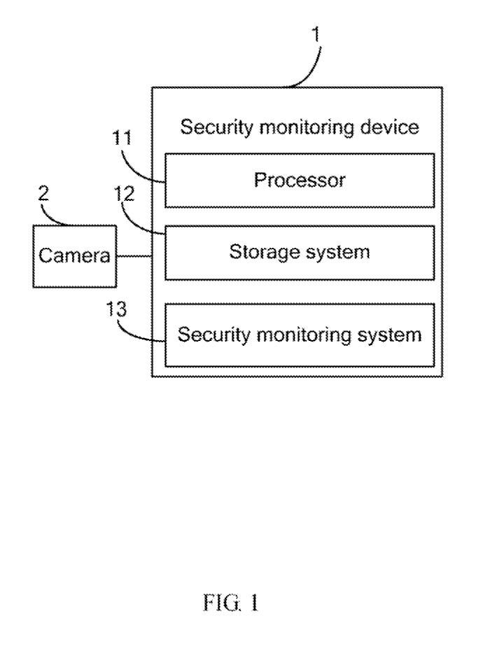

Referring to FIG. 1, a schematic diagram illustrating a security monitoring device 1 connected to a camera 2 is shown. The security monitoring device 1 determines whether an object is lost from a monitoring place or remained in the monitoring place according to the image captured by the camera 2, and generates a prompt message to prompt the user when one object(s) is lost or remained in the monitoring place.

The camera 2 is to capture images of the monitoring place. The captured images include distance information between the camera 2 and the objects in the monitoring place. In the embodiment, the camera 2 is a TOF (Time of Flight) camera.

The security monitoring device 1 includes at least one processor 11, a storage system 12, and a security monitoring system 13. In the embodiment, the number of the processor 11 is one. In an alternative embodiment, the number of the processor 11 is more than one.

The storage system 12 stores a standard 3D person model and a map. The standard 3D person model is built according to a number of person images pre-collected by the camera 2 and the distance information between the camera 2 and the person recorded in the pre-collected person images. The map consists of a number of object models of different places. Each object model is pre-collected by capturing the objects images using the camera 2 in one monitoring place when there is no object(s) lost or remained in the one monitoring place.

The security monitoring system 13 further includes an area setting module 131, an image obtaining module 132, an object detecting module 133, an image analysis module 134, and an executing module 135. One or more programs of the function modules may be stored in the storage system 12 and executed by the processor 11. In general, the word “module,” as used herein, refers to logic embodied in hardware or firmware, or to a collection of software instructions, written in a programming language. The software instructions in the modules may be embedded in firmware, such as an erasable programmable read only memory (EPROM). The modules described herein may be implemented as either software and/or hardware modules and may be stored in any type of computer-readable medium or other storage device.

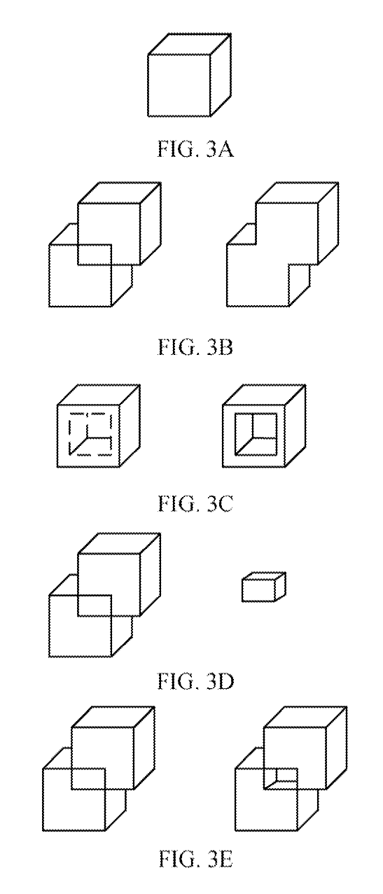

The area setting module 131 is operable to obtain the map from the storage system in response to the user operation, obtain the image of a desired place from the map in response to the user operation, and determine the monitoring place as a range of the place to be monitored in response to user selections. In the embodiment, the user selections include a first selection, a second selection, a third selection, a fourth selection, and a fifth selection. The first selection is an operation to select a single object in the image (see FIG. 3A). The second selection is a series of operations to select two or more objects in the image (see FIG. 3B). The third selection is a series of operations to select an object which is a second object subtracted from a first object in the image (see FIG. 3C). The fourth selection is a series of operations to select an object which is an overlapping part between a first object and a second object in the image (see FIG. 3D). The fifth selection is a series of operations to select objects which is an overlapping part subtracted from a first object and a second object in the image (see FIG. 3E). In FIGS. 3B-3E, the right figures show the determined monitoring place after selection.

The image obtaining module 132 is operable to obtain the captured image of the monitoring place.

The object detecting module 133 is operable to extract the distance information between the camera 2 and the captured objects from the captured image. In the embodiment, the object detecting module 133 extracts the distance information through Robust Real-time Object Detection Method which is well-known to the ordinary skilled in the art and thus is not described herein.

The image analysis module 134 is operable to compare the distance information of the obtained image with that of the corresponding object model stored in the storage system 12, to determine whether the obtained image matches the corresponding object model.

In detail, the image analysis module 134 is operable to compare the distance information of each pixel of the captured object(s) in the obtained image with that of the corresponding pixels in the object model. The image analysis module 134 is further operable to determine a ratio of the number of the pixels in the obtained image whose distance information is the same as that of the corresponding pixels in the object model to the number of the corresponding pixels in the object model, to determine whether the obtained image matches the object model.

If the determined ratio is greater than or equal to a preset value, the image analysis module 134 determines that the obtained image matches the object model. If the determined ratio is less than a preset value, the image analysis module 134 determines that the obtained image does not match the object model.

The executing module 135 is operable to determine that there is object(s) removed from or remained in the monitoring place when the obtained image does not match the corresponding object model, and generates a prompt message to prompt user that there is object(s) removed from or remained in the monitoring place.

In an alternative embodiment, the security monitoring system 13 further includes a person detecting module 136. The person detection module 136 is operable to extract image data from the obtained image when the obtained image does not match the object model, and compare the image data with character data of each of 3D person model, to determine whether there is any person in the monitoring place. If the image data does not match the character data of any of the 3D person model, the person detection module 136 determines that there is no person in the monitoring place. If image data matches the character data of one of the 3D person model, the person detection module 136 determines that there is person in the monitoring place.

The executing module 135 is operable to determine that there is object(s) removed from or remained in the monitoring place when there is no person in the monitoring place, and generates a prompt message to prompt user that there is object(s) removed from or remained in the monitoring place.

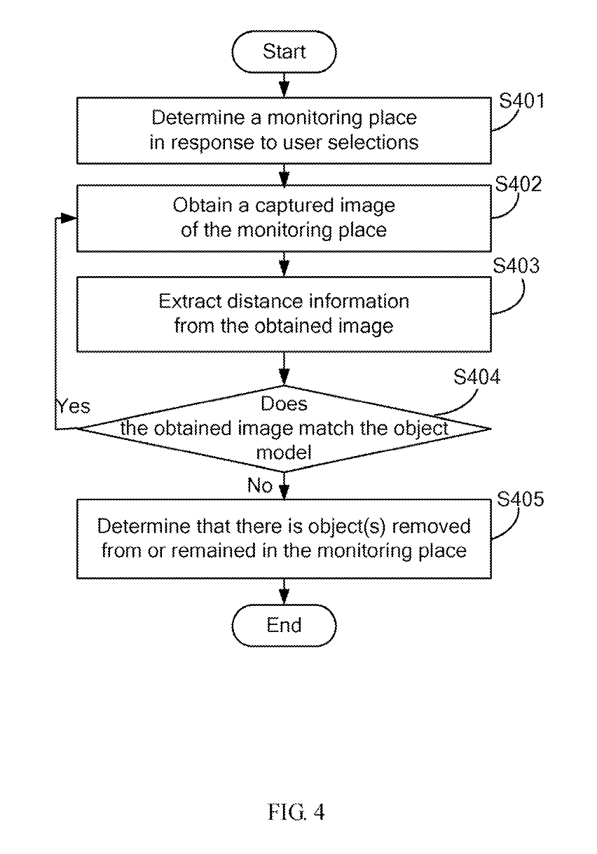

Referring to FIG. 4, a security monitoring method in accordance with an exemplary embodiment is shown. The security monitoring method is implemented by the security monitoring system 13 of FIG. 1.

In step S401, the area setting module 131 obtains the map from the storage system in response to the user operation, obtains the image of one place from the map in response to the user operation, and determines the monitoring place as a range of the place to be monitored in response to user selections.

In step S402, the image obtaining module 132 obtains the captured image of the monitoring place captured by the camera 2.

In step S403, the object detecting module 133 extracts the distance information from the obtained image.

In step S404, the image analysis module 134 compares the distance information of the obtained image with that of the corresponding object model, to determine whether the obtained image matches the corresponding object model. If the obtained image does not match the corresponding object model, the procedure goes to step S405. If the obtained image matches the corresponding the object model, the procedure goes to step S402.

In step S405, the executing module 135 determines that there is object(s) removed from or remained in the monitoring place, and generates a prompt message to prompt user that there is object(s) removed from or remained in the monitoring place.

In an alternative embodiment, the determination of the object(s) having been removed or remained is performed after the person detection module 136 determines that there is no person in the monitoring place.

In detail, the person detection module 136 extracts image data from the obtained image when the obtained image does not match the object model, and compare image data with the character data of each of 3D person model, to determine whether there is any person in the monitoring place. If the image data does not match the character data of any of the 3D person model, the person detection module 136 determines that there is no person in the monitoring place. If the image data matches the character data of one of the 3D person model, the person detection module 136 determines that there is person in the monitoring place.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A security monitoring system comprising:
an image obtaining module to obtain an image of a monitoring place captured by a camera, the image comprising distance information between the camera and captured objects;
an object detecting module to extract the distance information from the obtained image;
an image analysis module to compare the distance information of the obtained image with that of a pre-stored object model to determine whether the obtained image matches the pre-stored object model; and
an executing module to determine that there is object(s) removed from or remained in the monitoring place when the obtained image does not match the pre-stored object module, and generate a prompt message to prompt user that there is object(s) removed from or remained in the monitoring place.

2. The security monitoring system as described in claim 1, wherein the image analysis module compares the distance information of each of the pixels of the captured object(s) in the obtained image with that of corresponding pixels in the object model, determines a ratio of the number of pixels of the captured object(s) in the obtained image whose distance information is the same as that of the corresponding pixels in the object(s) model to the number of the corresponding pixels in the object model, and determines that the obtained image matches the object model if the determined ratio is greater than or equal to a preset value.

3. The security monitoring system as described in claim 1, further comprising a person detecting module, wherein the person detecting module compares image data of the obtained image with character data of each of 3D person models when the obtained image does not match the object model, and determines that there is no person in the monitoring place when the image data in the monitoring place does not match the character data of any of the 3D person models, the executing module determines that there is object(s) removed from or remained in the monitoring place when there is no person in the monitoring place.

4. The security monitoring system as described in claim 1, further comprising an area setting module, wherein the area setting module obtains a map of the monitoring place from the storage system in response to the user operation, obtains the image of one place from the map in response to the user operation, and determines the monitoring place as a range of the place to be monitored in response to user selections.

5. The security monitoring system as described in claim 4, wherein the user selections comprise a first selection, a second selection, a third selection, a fourth selection, and a fifth selection, the first selection is an operation to select a single object in the image, the second selection is a series of operations to select two or more objects in the image, the third selection is a series of operations to select an object which is subtracted a second object from a first object in the image, the fourth selection is a series of operations to select an object which is an overlapping part between a first object and a second object in the image, and the fifth selection is a series of operations to select objects which is subtracted an overlapping part from a first object and a second object in the image.

6. A security monitoring method comprising:
obtaining an image of a monitoring place captured by a camera, the image comprising distance information between the camera and captured objects;
extracting the distance information from the obtained image;
comparing the distance information of the obtained image with that of a pre-stored object model to determine whether the obtained image matches the pre-stored object model; and
determining that there is object(s) removed from or remained in the monitoring place when the obtained image does not match the pre-stored object module, and generating a prompt message to prompt user that there is object(s) removed from or remained in the monitoring place.

7. The security monitoring method as described in claim 6, wherein the comparing step further comprises:
comparing the distance information of each of the pixels of the captured object(s) in the obtained image with that of the corresponding pixels in the object model;
determining a ratio of the number of the pixels of the captured object(s) in the obtained image whose distance information is the same as that of the corresponding pixels in the object model to the number of the corresponding pixels in the object model; and
determining that the obtained image matches the object model if the determined ratio is greater than or equal to a preset value.

8. The security monitoring method as described in claim 6, wherein the security monitoring method further comprises:
comparing image data of the obtained image with character data of each of 3D person models when the obtained image does not match the object model, and determining that there is no person in the monitoring place when the image data in the monitoring place does not match the character data of any of the 3D person models; and
determining that there is object(s) removed from or remained in the monitoring place when there is no person in the monitoring place.

9. The security monitoring method as described in claim 6, wherein the security monitoring method further comprises:
obtaining a map from the storage system in response to the user operation;
obtaining the image of one place from the map in response to the user operation; and
determining the monitoring place as a range of the place to be monitored in response to user selections.

10. The security monitoring method as described in claim 9, wherein the user selections comprise a first selection, a second selection, a third selection, a fourth selection, and a fifth selection, the first selection is an operation to select a single object in the image, the second selection is a series of operations to select two or more objects in the image, the third selection is a series of operations to select an object which is subtracted a second object from a first object in the image, the fourth selection is a series of operations to select an object which is an overlapping part between a first object and a second object in the image, and the fifth selection is a series of operations to select objects which is subtracted an overlapping part from a first object and a second object in the image.

11. A storage medium storing a set of instructions, the set of instructions capable of being executed by a processor of an security monitoring device, cause the security monitoring device to perform a security monitoring method, the method comprising:
obtaining an image of a monitoring place captured by a camera, the image comprising distance information between the camera and captured objects;
extracting the distance information from the obtained image;
comparing the distance information of the obtained image with that of a pre-stored object model to determine whether the obtained image matches the pre-stored object model; and
determining that there is object(s) removed from or remained in the monitoring place when the obtained image does not match the pre-stored object module, and generating a prompt message to prompt user that there is object(s) removed from or remained in the monitoring place.

12. The storage medium as described in claim 11, wherein the comparing step further comprises:
comparing the distance information of each of the pixels of the captured object(s) in the obtained image with that of the corresponding pixels in the object model;
determining a ratio of the number of the pixels of the captured object(s) in the obtained image whose distance information is the same as the corresponding pixels in the object model, to the number of the corresponding pixels in the object model; and
determining that the obtained image matches the object model if the determined ratio is greater than or equal to a preset value.

13. The storage medium as described in claim 11, wherein the method further comprises:
comparing image data of the obtained image with character data of each of the 3D person models when the obtained image does not match the object model, and determining that there is not one person in the monitoring place when the image data in the monitoring place does not match the character data of any of the 3D person models; and
determining that there is object(s) removed from or remained in the monitoring place when there is no person in the monitoring place.

14. The storage medium as described in claim 11, wherein the method further comprises:
obtaining the map from the storage system in response to the user operation;
obtaining the image of one place from the map in response to the user operation; and
determining the monitoring place as a range of the place to be monitored in response to user selections.

15. The storage medium as described in claim 14, wherein the user selections comprise a first selection, a second selection, a third selection, a fourth selection, and a fifth selection, the first selection is an operation to select a single object in the image, the second selection is a series of operations to select two or more objects in the image, the third selection is a series of operations to select an object which is subtracted a second object from a first object in the image, the fourth selection is a series of operations to select an object which is an overlapping part between a first object and a second object in the image, and the fifth selection is a series of operations to select objects which is subtracted an overlapping part from a first object and a second object in the image.
